(19) United States
(12) Patent Application Publication
(10) Pub. No.: US 2017/0087393 A1
(43) Pub. Date: Mar. 30, 2017

(54) FIRE SUPPRESSION AND/OR EXTINGUISHMENT SYSTEMS AND DEVICES

(71) Applicant: GRAVITY WELLS TECHNOLOGY, INC., BRONX, NY (US)

(72) Inventor: KENT BUTLER, BRONX, NY (US)

(73) Assignee: GRAVITY WELLS TECHNOLOGY, INC., BRONX, NY (US)

(21) Appl. No.: 14/865,738

(22) Filed: Sep. 25, 2015

(51) Int. Cl. A62C 3/02; A62C 13/62

(52) U.S. Cl. CPC A62C 3/0292; A62C 13/62

(57) ABSTRACT

The present invention features systems, methods and devices directed to fire suppression and/or extinguishment using solid carbon dioxide and/or liquid or aqueous hydrogen. Systems and methods of deployment and/or dispersal of carbon dioxide and hydrogen (which would form water at its deployment location) are contemplated. The present invention also contemplates method(s) of fire suppression and/or extinguishment which may include the steps of: carbon dioxide canister deployment, formation of a carbon dioxide curtain and hydrogen deployment and/or dispersal.

### CROSS-REFERENCE TO RELATED APPLICATIONS

This Application claims the benefit of, and is related to, the following Applicant's provisional patent application: U.S. Provisional Patent Application No. 62/055,108 titled “Method(s), Process(es), System(s), Apparatus(es) for Fire Suppression and/or Extinguishment” filed Sep. 25, 2014, which is incorporated herein in its entirety.

### FIELD OF THE INVENTION

The present invention relates, in general, to systems, methods and devices for fire suppression and extinguishing. Specifically, systems, methods and devices for forest fire suppression and extinguishment.

### BACKGROUND OF THE INVENTION

Forest fires, as a result of drought (global warming), human activities, etc. are an increasing problem for parts of the world that are prone to these conditions. Often, the means with which we eliminate or contain these forest fires are water and/or fire retardants both of which are not quite effective in extinguishing or suppressing the fires—especially medium to large scale fires. As such, there exists a need for an efficient and effective means of forest fire suppression and extinguishment.

### SUMMARY OF THE INVENTION

Aspects of embodiments of the present invention contemplate the use of increased amounts of suppressant e.g. carbon dioxide (CO₂), and increased amounts of water (i.e. H₂O) which are to be delivered to the site.

The systems, methods and devices contemplated by aspects of embodiments of the present invention may be used by any fire fighting entity around the world to contain and control fires that have become prevalent in certain parts of the world, some as a result of higher temperatures due to global warming, direct human factors etc.

One advantage of the present invention is that use of the system as contemplated by aspects of embodiments of the present invention enable the quick extinguishment of fires, a decrease in loss of life & property and the provision of more suppressant and/or extinguisher per transport.

In an aspect of an embodiment of the present invention, there may be two parts of aspects to the invention. The first part may function as a suppressor and the second part may function as an extinguisher. In an aspect of an embodiment of the present invention, the first part may rely on shape and state of matter for its functionality and effectiveness. In another aspect, carbon dioxide may be frozen to its solid form and then deployed as a solid in a variety of shapes. In some cases, laying down this form of carbon dioxide as suppressant will cause the fire to be extinguished. In the event of a huge fire, the dispersal of the solid may provide a 3-dimensional curtain for fire containment. This is to stop the fire from progressing.

The second part, in another aspect of an embodiment of the present invention, may be formed first by a hollowed out sphere made of solid ice. Additional shapes are also contemplated. Within this sphere, the liquid and/or aqueous form of hydrogen (H₂) may be placed.

One reason for keeping the container as solid ice is to transport the liquid and/or aqueous hydrogen which resides in the center of the solid ice. When formed, this “container” will disperse the liquid and/or aqueous hydrogen over an area to extinguish the fire by:
1. Denying oxygen to the fire;
2. Establishing a blast radius within the carbon dioxide curtain; and
3. Forming water i.e. the end product of the reaction

2H₂+O₂→2H₂O,

Water, in its liquid form, is normally brought to fires currently. Water has been used for millennia to put out or extinguish fires probably as long as man has used fire. Carbon dioxide has also been used to suppress and extinguish fires for some time. However, if an equivalent or larger mass of hydrogen is brought to the site and combined with the oxygen that is present at the site, more water would be brought to bear in combating the fire. While carbon dioxide and water are currently used to suppress and extinguish water today, they are not used in the particular states and shapes contemplated in the present invention. The states and shapes contemplated in aspects of embodiments of the present invention increase the quantity of water brought to the fire site and also more efficiently suppress and extinguish fires.

Aspects of embodiments of the present invention contemplate use of concentrated forms of each to bring as much of the constituent chemicals (in the case of water, hydrogen and oxygen) to the fire. Forest fires are not always conveniently placed near a water source. However, by transporting and concentrating hydrogen which is light and combining it with oxygen molecules, present at the site, molecular water may be formed at the site. Therefore, by placing liquid and/or aqueous hydrogen in a container of sorts, as contemplated by aspects of embodiments of the present invention, one can, in effect, concentrate water to bring to the site of a fire.

The placement or deployment of carbon dioxide capsules can be used to suppress and extinguish smaller fires. In one aspect of an embodiment of the present invention, carbon dioxide, in its solid, concentrated capsular form, may be delivered to the site by air. In the event of a huge or larger fires, carbon dioxide capsules may also be placed in order to suppress the cinders that may be formed as a result of the exploding liquid and/or aqueous hydrogen resulting from the deployment of the solid ice capsules or containers containing liquid or aqueous hydrogen.

Here, the carbon dioxide capsules to form a “curtain” which would suppress the progress of the fire and also extinguish or suppress cinders emanating from the fire itself or from the production of molecular water following the highly explosive reaction of the liquid and/or aqueous hydrogen with oxygen present at the site. Smaller sized hydrogen capsules (containing liquid and/or aqueous hydrogen) may be placed beside the curtain and larger capsules may be placed near the interior of the hottest part of the fire.

In another aspect of an embodiment of the present invention, it is possible to use solid carbon dioxide (in the event of a rescue) within a container of ice. This may be carried in an insulated thermos-like container by the firefighter. They may also have some use in urban settings.

In an aspect of an embodiment of the present invention, solid carbon dioxide pellets may be placed in a canister/container configured to emit the carbon dioxide gas formed as a result of the canister/container being placed in proximity to a fire. The heat from the fire enables the state change of the carbon dioxide pellets from solid to gaseous state. The gaseous carbon dioxide may then be channeled towards the fire as a suppressant/extinguisher. In another aspect, the gaseous carbon dioxide may be used to form a curtain to suppress the progress of a fire. In another aspect, multiple canisters or containers may be used to further form the curtain. The carbon dioxide device(s) may be placed in an insulated container to be launched as a projectile. They may also be carried by firefighters and used by them to retard an advancing flame in order to provide a means of egress for them (they may be placed as the firefighters retreat from the fire, thereby suppressing the fire as they retreat). The hydrogen device may be deployed a number of ways including by remotely controlled vehicles (e.g. drones, parachutes etc.) which may be used to place the hydrogen devices at the precise locations. Deployment may also be made, in another aspect of an embodiment, by way of a metal container with a parachute to disperse the hydrogen above the fire. When this is done, the hydrogen would bond with available oxygen atoms to form water which then falls upon the fire and help extinguish it.

In another aspect of an embodiment of the present invention, liquid and/or aqueous hydrogen may be deployed within a container and using a parachute thereby dispersing the liquid and/or aqueous hydrogen above the fire. The water formed may then fall onto the fire thereby extinguishing it.

In another aspect of an embodiment of the present invention, a system of fire suppression and extinguishment is contemplated. Here, as a first step, carbon dioxide canisters may be deployed to reduce the amount of embers from the fire as these embers may reignite the fire in another area. The carbon dioxide may also be used to separate the combustibles away from oxygen in the area. The ensuing gaseous carbon dioxide may also be used to create a curtain around an area to suppress the fire. Next, in a subsequent step, liquid and/or aqueous hydrogen may be deployed to the curtained off area. The hydrogen may be deployed in various forms, including, without limitation, within a core of frozen ice, in canisters, etc. Deployment of the liquid and/or aqueous hydrogen, which, when exposed to the available oxygen, would explosively form water at the site. In addition, the reaction of the liquid and/or aqueous hydrogen with the oxygen further deprives the fire of additional oxygen used to fuel the fire.

In another aspect of an embodiment of the present invention, the liquid and/or aqueous hydrogen and the carbon dioxide may be deployed in separate canisters. In one aspect, they may be deployed in a dual use canister. They may also be deployed as projectiles (being shot into a fire site) or dropped from the air (via parachutes, drones etc.).

An aspect of an embodiment of the present invention contemplates a device for fire suppression and extinguishment which may include a solid shell of ice, and fire suppression and extinguishment chemical encased within the solid shell of ice.

In an aspect of an embodiment of the present invention the fire suppression and extinguishment chemical may be any one of the following: liquid hydrogen, aqueous hydrogen or solid carbon dioxide.

In an aspect of an embodiment of the present invention the device may be configured to be deployed from the air by any one of: a drone, parachute or a plane.

In an aspect of an embodiment of the present invention the device may be spherical in shape.

In an aspect of an embodiment of the present invention the device may have leg(s) extending from the device's exterior.

In an aspect of an embodiment of the present invention the solid carbon dioxide may be encased within an internal shell located within the solid shell of ice.

In an aspect of an embodiment of the present invention the internal shell may include vent(s) for releasing gaseous carbon dioxide when the solid carbon dioxide has sublimated.

Another aspect of an embodiment of the present invention contemplates a device for fire suppression and extinguishment which may include a cylindrical body, solid carbon dioxide located within the cylindrical body, and vent(s) for releasing gaseous carbon dioxide resulting from the sublimation of the solid carbon dioxide as a result of deployment of the device within close proximity of a fire.

In another aspect of an embodiment of the present invention, the vent(s) may be rotatable about its axis. This would enable the vent(s) proper positioning to vent the gaseous carbon dioxide towards the fire.

In another aspect of an embodiment of the present invention, the device may include a dispersal mechanism for regulating the release of gaseous carbon dioxide or releasing it at a high velocity and/or with precision using the dispersal mechanism. In one aspect, this may involve a mechanical blower/fan/venter of sorts. In another aspect, this may be made possible by the configuration of the canister/container outlet through which the carbon dioxide gas is allowed to escape.

A yet other aspect of an embodiment of the present invention contemplates a device for fire suppression and extinguishment which may include an insulated interior of the device, solid carbon dioxide within the insulated interior, a tapered portion of the device which enables easy deployment of the device, and a cap located at an end opposite the tapered portion of the device.

A further aspect of an embodiment of the present invention contemplates a system for fire suppression and extinguishment which may include a first curtain of fire suppression and extinguishment in close proximity to a fire, the first curtain which may have a plurality of a first set of spherical ice shell devices having a core of hydrogen and having a first diameter. The system may also include a second curtain of fire suppression and extinguishment, adjacent the first curtain and further away from the fire, the second curtain which may have a plurality of a second set of spherical ice shell devices having a core of hydrogen and having a second diameter, wherein the second diameter may be less than the first diameter. The system may additionally include a third curtain of fire suppression and extinguishment which may have a plurality of canister comprising of solid carbon dioxide, the third curtain being deployed further away from the fire and adjacent to the second curtain.

In a further aspect of an embodiment of the present invention the method and system of fire suppression and/or extinguishment are disclosed where the method and system may include the steps of: carbon dioxide canister deployment, formation of a carbon dioxide curtain; and hydrogen deployment and/or dispersal.

In a further aspect of an embodiment of the present invention the method and system of fire suppression and/or extinguishment may contemplate the deployment of hydrogen and/or dispersal being done by way of a parachute over a designated area.

In a further aspect of an embodiment of the present invention the method(s) of fire suppression and/or extinguishment may include the step of establishing a blast radius for the hydrogen.

Further aspects of embodiments of the present invention contemplate combinations, arrangements, and/or permutations of the aspects disclosed above. Additional aspects, objectives, features and advantages of the present invention will become apparent from the following description of the preferred embodiments with reference to the attached drawings.

### BRIEF DESCRIPTION OF THE DRAWINGS

FIG. 1A illustrates a cross-sectional view of a canister, sphere or capsule containing liquid/aqueous hydrogen according to an aspect of an embodiment of the present invention.

FIG. 1B illustrates a cross-sectional view of a canister, sphere or capsule containing solid carbon dioxide according to an aspect of an embodiment of the present invention.

FIG. 1C illustrates a cross-sectional view of a canister, sphere or capsule containing solid carbon dioxide in its application to a fire according to an aspect of an embodiment of the present invention.

FIG. 1D illustrates a cross-sectional view of another canister, sphere or capsule containing solid carbon dioxide in its application to a fire according to an aspect of an embodiment of the present invention.

FIGS. 2A and 2B illustrate side views of exemplary carbon dioxide canisters/containers according to aspects of embodiments of the present invention.

FIG. 3 illustrates a side view of another exemplary carbon dioxide canister/container according to an aspect of an embodiment of the present invention.

FIG. 4 illustrates an exemplary deployment scheme or system for fire suppression and/or extinguishment according to an aspect of an embodiment of the present invention.

### DETAILED DESCRIPTION OF THE INVENTION

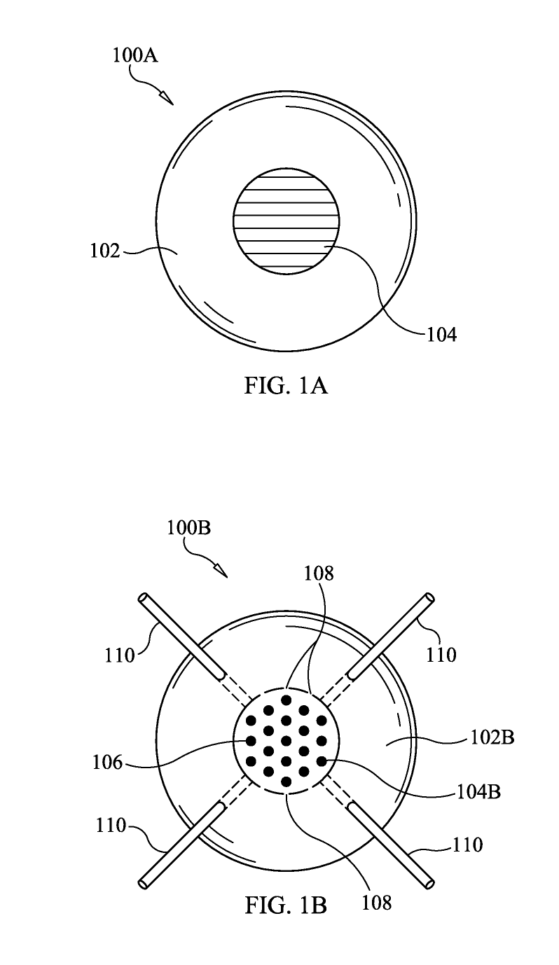

Referring now to FIG. 1A, a cross-sectional view of a canister, sphere or capsule 100A containing liquid/aqueous hydrogen 104 is shown according to an aspect of an embodiment of the present invention. Here, in an aspect of an embodiment of the present invention, canister, sphere or capsule 100 may comprise of an outer shell of solid ice 102 which encases liquid or aqueous hydrogen 104 within its core. Canister, sphere or capsule 100 may be transported and deployed to the site of a forest fire and when deployed, the solid ice would melt in the heat of the fire. As the solid ice shell 102 melts, the liquid or aqueous hydrogen 104 would come in to contact with the surrounding oxygen and would react with the oxygen to form water. This action would also further deprive the surrounding fire of oxygen needed to sustain the fire.

Referring now to FIG. 1B, a cross-sectional view of a canister, sphere or capsule 100B containing solid carbon dioxide 106 is shown according to an aspect of an embodiment of the present invention. Capsule 100B is shown with an outer casing of solid ice 102B. Casing 102B may additionally enclose shell 104B (which may be a membrane made of fire suppressing material/chemical(s)) within which may be solid carbon dioxide pellets 106. Shell 104B may also include vents 108 which would be sealed with ice of casing 102B. Capsule 100B may also include legs 110 which enable capsule 100B to be propped up after deployment—especially after being deployed from the air. In one aspect of an embodiment of the present invention, capsule 100B may include ice shell 102B and just a core of solid carbon dioxide 106 without shell 104B.

Referring now to FIG. 1C, a cross-sectional view of canister, sphere or capsule 100C containing solid carbon dioxide 106 shows its application to a fire according to an aspect of an embodiment of the present invention. Here, capsule 100C is shown being propped up against the fire by legs 110 and a portion of solid ice casing 102B has melted thus enabling the heat from the fire to sublimate carbon dioxide pellets 106. The ensuing gaseous carbon dioxide 112 may then escape by way of vents 108 or directly into the fire, thereby suppressing or extinguishing the surrounding fire.

Referring now to FIG. 1D, a cross-sectional view of canister, sphere or capsule 100D containing solid carbon dioxide 106 shows its application to a fire according to an aspect of an embodiment of the present invention. Here, capsule 100D is shown having carbon dioxide pellets 106 directly encased within capsule 100D without an internal shell. Capsule 100D is also shown being propped up against the fire by legs 110 and a portion of solid ice casing 102B has melted thus enabling the heat from the fire to sublimate carbon dioxide pellets 106. The ensuing gaseous carbon dioxide 112 may then escape directly into the fire, thereby suppressing or extinguishing the surrounding fire.

The thickness of the ice shell of canister, sphere or capsule 100A or 100B surrounding the core of liquid or aqueous hydrogen 104 and/or shell 104B may be made with different thicknesses and sizes depending on the intended application. For example, in applications requiring a quick deployment of hydrogen to form water, the ice may have a thinner thickness. In other applications where the urgency may not be great, the shell thickness may be much thicker. Bigger sizes of 100A or 100B are also contemplated where larger fires are being engaged and where larger amounts of hydrogen (thus water) and carbon dioxide must be brought to the site to further suppress or extinguish the fire.

Legs 110 may be made of different compositions and may be of different thicknesses. In one aspect of an embodiment of the present invention, legs 110 may be made of any one of wood, metal, or material/chemical composition that could assist in the suppression or extinguishment of the fire. In another aspect, the legs may also be ice or solid carbon dioxide.

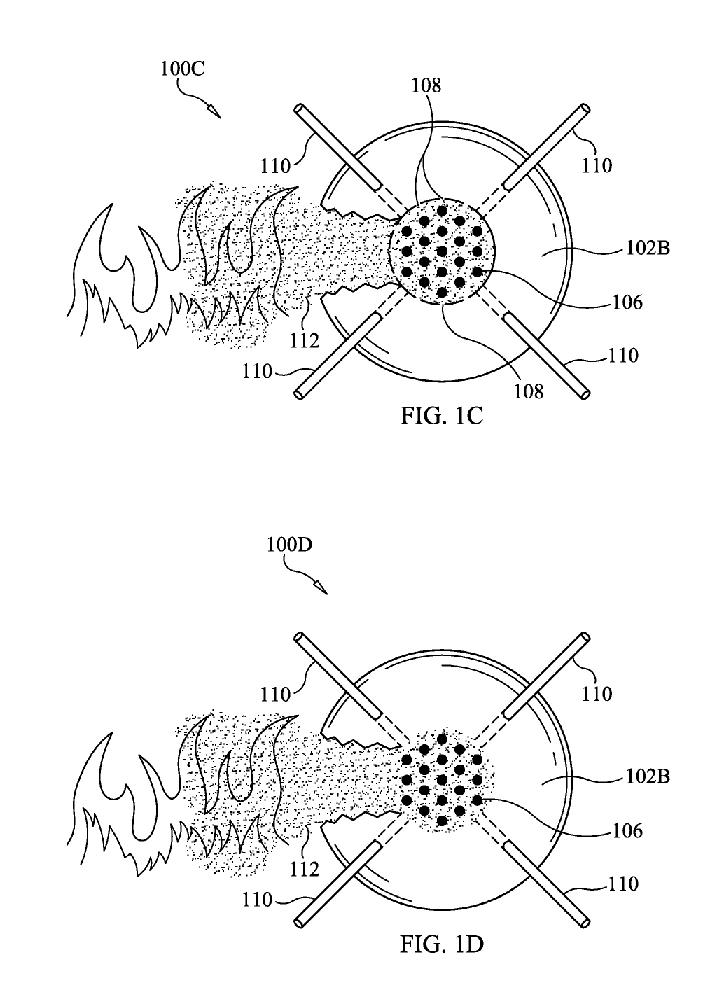

Referring now to FIG. 2A, a side view of an exemplary CO₂ canisters/containers 200 is shown according to an aspect of an embodiment of the present invention. Canister 200 may be formed in a variety of shapes and may include solid carbon dioxide pellets 204 within canister 200. Upon application of canister 200 or upon heating of canister 200 by an advancing fire, carbon dioxide pellets 204 would sublimate and turn into gaseous carbon dioxide 206 which then is funneled out of canister 200 by way of funnel or vent 208 to suppress or extinguish the surrounding fire.

Referring now to FIG. 2B, a side view of another exemplary CO₂ canisters/containers 200 is shown according to an aspect of an embodiment of the present invention. Canister 200 may be formed in a variety of shapes and may include solid carbon dioxide pellets 204 within canister 200. Upon application of canister 200 or upon heating of canister 200 by an advancing fire, carbon dioxide pellets 204 would sublimate and turn into gaseous carbon dioxide 206. Canister 200 may also include dispersal mechanism 210 which may regulate the dispersion of gaseous carbon dioxide 206. Dispersal mechanism 210 may a device that works under pressure thereby dispersing carbon dioxide 206 under pressure with sufficient force that would extinguish a surrounding fire. In another aspect of an embodiment of the present invention, dispersal mechanism 210 may also include a thermostat (not shown) that may help determine when to release gaseous carbon dioxide 206 when the heat from the fire has reached a certain threshold temperature.

In another aspect of an embodiment of the present invention, dispersal mechanism 210 may include a valve mechanism (not shown) that may also help in the regulation of the release of gaseous carbon dioxide 206 In yet another aspect of an embodiment of the present invention, dispersal mechanism 210 may also include electronics (not shown) that would, in conjunction with the thermostat to aid in releasing the gaseous carbon dioxide 206 at certain times, in certain quantities, at certain temperatures etc. then is funneled out of canister 200 by way of funnel or vent 208 to suppress or extinguish the surrounding fire. Dispersal mechanism 210 may also include a processor and a transmitter (not shown) as part of the electronics which would enable remote control of canister 200. Firefighters, after deployment of multiple canisters 200 may then safely control release of gaseous carbon dioxide 206 from canisters 200 remotely once the fire has reached the area. This may be done using a remote device which may be mobile/portable or may be done from a command station having computers, transmitters etc. for generating and transmitting the necessary control signals to canisters 200. An aspect of an embodiment of the present invention contemplates use of different wireless technologies to effect wireless communications between canisters 200 and the firefighters.

In a yet further aspect of an embodiment of the present invention, funnel or vent 208 may be mechanically rotatable about its axis. As such, firefighters may be able to turn funnel or vent 208 towards the fire if it was not accurately directed towards the fire when canister 200 was originally deployed. In another aspect of this embodiment, control may be effected remotely using the processor and transmitter of dispersal mechanism 210.

In a yet further aspect of an embodiment of the present invention, canister 200 may have more than one vent 208. In a yet further aspect of an embodiment of the present invention, the vent(s) 208 of canister 200 may be at different angles. These configurations help ensure that gaseous carbon dioxide 206 may be dispersed in ways that may be most efficient in suppressing or extinguishing the surrounding fire. In yet another aspect of an embodiment of the present invention, vent(s) 208 may also be controlled remotely using a mechanical component (not shown) of canister 200 in conjunction with processor and transmitter to effect the change of direction of vent(s) 208 in terms of the direction, angle etc. of vent(s) 208. In a yet further aspect of an embodiment of the present invention, thermostat of canister 200 may alert the processor of the direction of the fire (by determining which side of canister 200 is hottest) which then may be relayed to the remotely located firefighter who then would be able to send a command to canister to turn or direct vent(s) 208 towards the direction of the fire.

In an aspect of an embodiment of the present invention, canister 200 may additionally include a tapered end (not shown) that would facilitate deployment of canister 200 into the ground.

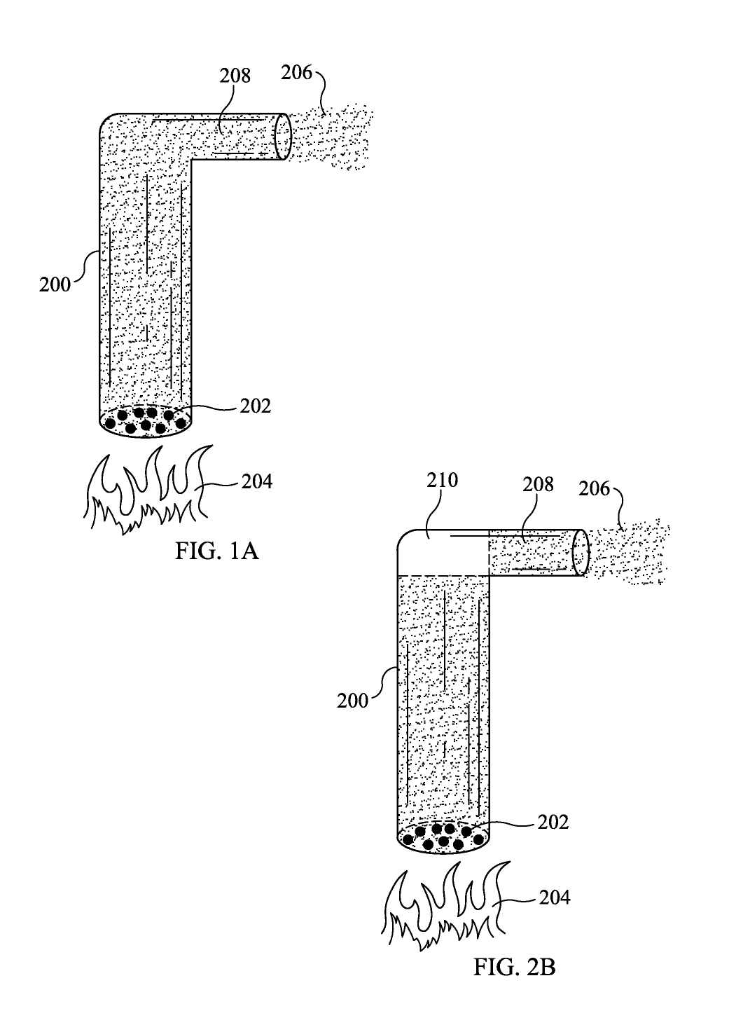

Referring now to FIG. 3, a side view of another exemplary CO₂ canister/container 300 is shown according to an aspect of an embodiment of the present invention. Canister 300 may be portable and may be carried by firefighters going to fight a fire. Canister 300 may include solid carbon dioxide 306 encased within an insulated interior 304 of canister 300. Canister 300 may also include tapered portion 308 which enables easy deployment into the ground as against an approaching fire. Canister 300 may also include a cap 302 which may be removed or unscrewed to release the gaseous carbon dioxide that would form once the heat of the approaching fire has converted solid carbon dioxide 306 into its gaseous form. Firefighters may use canister 300 in different situations including situations where they need to retreat from the approaching fire and thus would need to suppress the fire in order to effect their retreat. As such, canisters 300 would be placed in position behind the retreating firefighters with their caps 302 unscrewed or removed. Once the fire reaches the canisters, the solid carbon dioxide within is sublimated forming gaseous carbon dioxide which is released directly to the and thus suppressing or extinguishing the surrounding fire and giving the firefighters extra time to make their retreat.

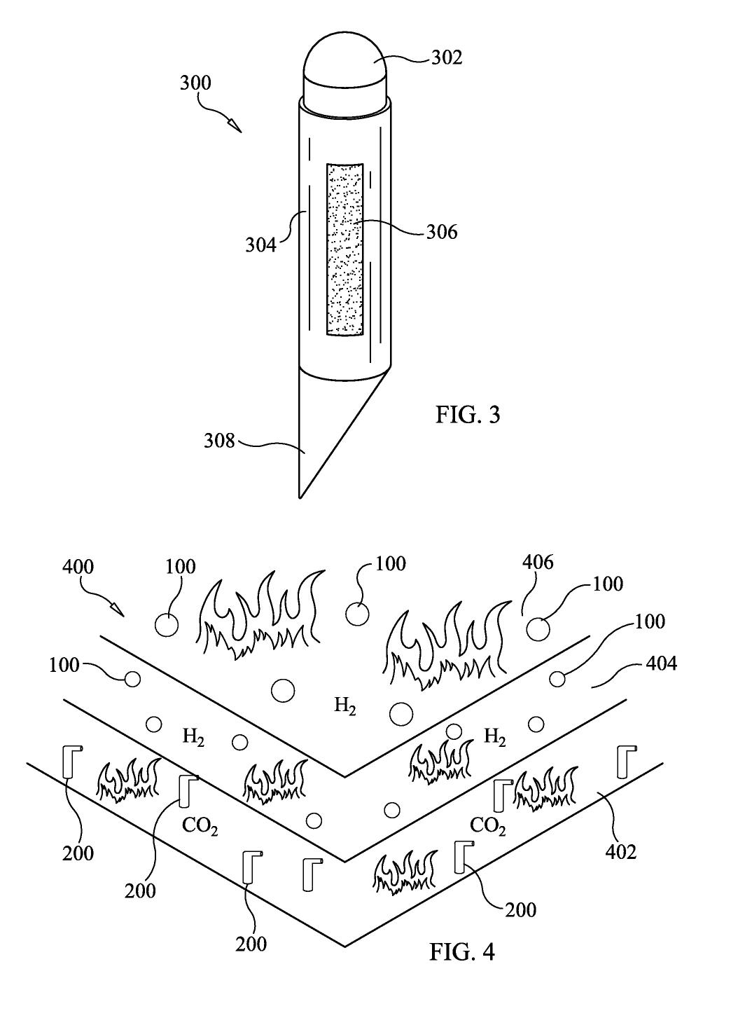

Referring now to FIG. 4, an exemplary deployment scheme or system 400 for fire suppression and/or extinguishment is shown according to an aspect of an embodiment of the present invention. Scheme or system 400 makes use of the deployment of fire suppression and/or extinguishment devices 100A and 200 is areas designated as 402, 404 and 406 with increasing or progressive fire intensity from area 402 to area 406. Capsules 100A may be deployed in area 406 where the fire intensity in highest. Capsules 100A that are deployed here may be larger to accommodate more liquid or aqueous hydrogen in order to bring more extinguishing force to the fire as more hydrogen would ensure that more water would be formed when capsules 100A are deployed and may explode sucking in more oxygen thereby depriving the fire of the oxygen needed to sustain the fire. Additional, but smaller capsules 100A may be deployed in area 404 adjacent to area 406 to provide the same effect as that impacted in area 406. Canisters 200 may be deployed in area 402 adjacent to area 404. Canisters 200 containing solid carbon dioxide may be deployed to help extinguish any embers that may emanate from areas 404 and/or 406. In an aspect of an embodiment of the present invention, the approaching fire may be suppressed or extinguished by operation and control of canisters 200 having dispersal mechanisms 210 and smart electronics that enable remote firefighter control of the gaseous carbon dioxide formed within canisters 200 as a result of the heat from the approaching fire.

Although this present invention has been disclosed with reference to specific forms and embodiments, it will be evident that a great number of variations may be made without departing from the spirit and scope of the present invention. For example, equivalent elements may be substituted for those specifically disclosed and certain features of the present invention may be used independently of other features—all without departing from the present invention as defined in the appended claims

What is claimed is:

1. A device for fire suppression and extinguishment comprising of: a solid shell of ice; and fire suppression and extinguishment chemical encased within the solid shell of ice.

2. The device of claim 1, wherein the fire suppression and extinguishment chemical is any one of the following: liquid hydrogen, aqueous hydrogen or solid carbon dioxide.

3. The device of claim 1, wherein the device is configured to be deployed from the air by any one of: a drone, parachute or a plane.

4. The device of claim 1, wherein the device is spherical in shape.

5. The device of claim 1 further comprising of at least two legs extending from the device's exterior.

6. The device of claim 2 wherein the solid carbon dioxide is encased within an internal shell located within the solid shell of ice.

7. The device of claim 6, wherein the internal shell comprises of at least one vent for releasing gaseous carbon dioxide when the solid carbon dioxide has sublimated.

8. A device for fire suppression and extinguishment comprising of:
a cylindrical body;
solid carbon dioxide located within the cylindrical body; and
at least one vent for releasing gaseous carbon dioxide resulting from the sublimation of the solid carbon dioxide as a result of deployment of the device within close proximity of a fire.

9. The device of claim 8 wherein the vent is rotatable about its axis.

10. The device of claim 8 further comprising of a dispersal mechanism for regulating the release of gaseous carbon dioxide.

11. A device for fire suppression and extinguishment comprising of:
an insulated interior of the device;
solid carbon dioxide within the insulated interior;
a tapered portion of the device which enables easy deployment of the device; and
a cap located at an end opposite the tapered portion of the device.

12. A system for fire suppression and extinguishment comprising:
a first curtain of fire suppression and extinguishment in close proximity to a fire, the first curtain comprising a plurality of a first set of spherical ice shell devices having a core of hydrogen and having a first diameter;
a second curtain of fire suppression and extinguishment, adjacent the first curtain and further away from the fire, the second curtain comprising a plurality of a second set of spherical ice shell devices having a core of hydrogen and having a second diameter, wherein the second diameter is less than the first diameter; and
a third curtain of fire suppression and extinguishment comprising a plurality of canister comprising of solid carbon dioxide, the third curtain being deployed further away from the fire and adjacent to the second curtain.
